(19) United States
(12) Patent Application Publication
(10) Pub. No.: US 2006/0032713 A1
(43) Pub. Date: Feb. 16, 2006

(54) Device for operating vehicle brakes

(76) Inventors: Jaume Prat Terradas, Barcelona (ES); Jesus Alvarez Florez, Barcelona (ES); Jordi Jornet Vidal, Terrassa (ES); Ismael Callejon I Agramunt, Barcelona (ES)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/141,820

(22) Filed: Jun. 1, 2005

Related U.S. Application Data
(63) Continuation of application No. PCT/EP03/14072, filed on Dec. 11, 2003.

(30) Foreign Application Priority Data
Dec. 11, 2002 (DE) 102 57 865.6

(51) Int. Cl. B60T 8/72

(52) U.S. Cl. 188/181 R

(57) ABSTRACT

An electric device for operating vehicle brakes using a pulling element and an operating motor with a rotatable driving axis. The device includes a centrifugal assembly with rotatable parts which are radially outwardly movable due to centrifugal forces. The centrifugal assembly also comprises at least one translational element, which is disposed so that it is capable of axial movement that is related to the rotational speed of the driving axis. The axial movement of the translational element translates to movement of the pulling element. Several implementations provide reduced power consumption and less friction and heat losses.

### RELATED APPLICATIONS

The present application claims priority under 35 USC §§ 119 and 365 to commonly owned and assigned Application No. PCT/EP2003/014072, filed Dec. 11, 2003 entitled Device for Operating Vehicie Brakes, which claims priority to German application 102 57 865.6 filed Dec. 11, 2002, both of which are incorporated herein by reference.

### FIELD OF THE INVENTION

The present invention relates to vehicle brakes. More specifically, the present invention relates to devices for operating vehicle brakes.

### BACKGROUND OF THE INVENTION

Braking systems are known to be used in motor vehicles as parking brakes (handbrakes) so that the vehicle cannot unintentionally move in the parked state.

Devices are known that use both an electric motor and a corresponding gear to apply the vehicle brakes. These known devices, however, have the disadvantage that they are noisy and that they cause a comparatively high power consumption. Furthermore, the gear can become comparatively hot and there are disadvantageous friction effects. A device of this kind is disclosed and described in the WO 98/56633.

Although present devices are functional, they are not sufficiently accurate or otherwise satisfactory. Accordingly, a system and method are needed to address the shortfalls of present technology and to provide other new and innovative features.

### SUMMARY OF THE INVENTION

According to one embodiment, the invention may be characterized as a device for operating vehicle brakes using a pulling element connected with the vehicle brakes and an operating motor comprising a rotating driving axis. The device according to this embodiment comprises a centrifugal arrangement which is in operating connection with the mentioned driving axis and which comprises a translational element. The translational element is formed such that it can perform an axial movement related to the rotational speed of the driving axis. Finally, the translational element is coupled to the mentioned pulling element for operating the vehicle brake.

According to several embodiments, the rotational movement of a preferably electrical driving motor is utilized to create a centrifugal movement of parts or arms hingedly connected to the driving motor, which is transformed into an axial movement, wherein this axial movement is used for operating the brakes.

The present invention reduces the power consumption of the electric motor, since a comparatively low torque is necessary. Furthermore, there are no high friction creating parts, like gears, present. Accordingly, no gear noises are created by the device according to the invention. Finally, there are no disadvantageous heating effects. The rotating parts provide additionally a ventilating effect. Furthermore, the device according to the invention operates reliably and with reduced wear.

In variations, a decoupling device is implemented for decoupling the rotating centrifugal arrangement from the pulling element, so that the pulling element is not rotated, wherein the decoupling device is arranged between the centrifugal assembly and the pulling element.

According to another embodiment, it is particularly advantageous to construct the decoupling device as an axially guided slide and as a pivot bearing arranged on the slide, wherein the pivot bearing is an axial and a radial bearing. Thereby, the rotational movement is decoupled with comparatively low noise and friction. Thus, abrasion is considerably reduced.

The device according to yet another embodiment of the invention comprises a blocking assembly operable by actuators so that the operating motor has not to be operated continuously, for example, if the vehicle is parked, wherein the actuators are provided such that they can block the axial movement of the translational element.

In accordance with one variation, a blocking device that is secure and easy to manufacture is obtained when the blocking assembly comprises at least two blocking arms hinged on one side at rotational bearing points, each having a clamping region, wherein at least one blocking element connected to the slide is arranged between the blocking arms so that it can be fastened, wherein the mentioned actuators act on the blocking arms and are each arranged on the end of the blocking arms opposite to the rotational bearing points. Additionally, this embodiment leads to a compact construction.

The actuators in one embodiment are realized by electromagnets, which can open the blocking arms against the spring force of pulling ends arranged at the ends opposite to the rotational bearing points of the blocking arms. Thus, the actuators can be electrically controlled. Alternatively, the actuators can also be provided as clutch spring brakes.

In accordance with one variation, which is relatively easy to manufacture, the centrifugal assembly comprises a shaft connectable to the rotating axis of the operating motor and at least two rotating arms, hinged to the shaft, each having corresponding weights at their free ends and each a first bearing point and at least two pulling arms, which are respectively flexibly connected with one end thereof to a second bearing point, wherein the second bearing point is arranged at the rotating arm between the weight and the first bearing point of the respective rotating arm and which are respectively fixed with the other end to a slide at a third bearing point. Thereby, the slide is axially displaceable arranged at the mentioned shaft and a pulling spring is arranged between the respective second bearing point and the shaft.

In yet another variation, the operating motor, the centrifugal assembly, the decoupling device and the blocking assembly are arranged in a common housing as a single unit, which results in a particularly compact construction.

### BRIEF DESCRIPTION OF THE DRAWINGS

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

FIG. 1 a cross-section of the device according to the invention for operating vehicle brakes according to an embodiment of the present invention; and

FIG. 2 a schematic presentation of the operation of the present invention.

### DETAILED DESCRIPTION

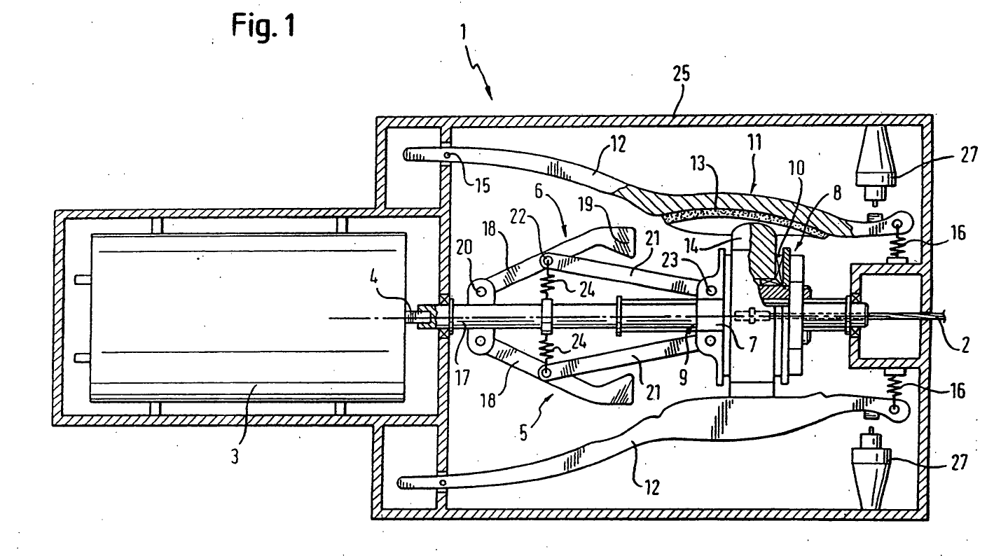

The device according to several embodiments of the present invention comprises an electric motor as operating motor 3, as shown on the left side in FIG. 1. The rotatable driving axis 4 of the motor is directly coupled to a shaft 17. The shaft 17 has a bearing on its two ends in a housing 25. A centrifugal assembly 5 is arranged at the shaft 17 close to the operating motor 3. The centrifugal assembly 5 has a symmetric construction and includes, on each side, a rotating arm 18, a pulling arm 21, a pulling spring 24 and a guidance coupled to a slide 9.

A bearing point 20 is respectively arranged at the shaft 17, rotating with the shaft 17. To this bearing point 20, a rotating arm 18 is rotatably supported. At the other end of the rotating arm 18, a weight 19 is present, which is formed such that the rotating arm 18 is in this part thicker or has a greater mass. A second bearing point 22 is arranged approximately in the center between the free end and the hinged end of the rotating arm 18, which is connected with a pulling arm 21. A pulling spring 24 is arranged between the shaft 17 and the second bearing point 22, which pulls the bearing arm 18 to the shaft 17. The other end of the pulling arm 21 is connected to a third bearing point 23 which is movable in parallel to the axis of the shaft 17.

A slide 9 is connected to the third bearing point 23 which is axially slidably arranged over the shaft 17. Some parts of the slide 9 are rotating together with the centrifugal assembly. Other parts of the slide 9 are decoupled from this rotating movement. Thereby, the slide 9 acts as a decoupling device 8. It comprises a fixed pivot bearing 10 and is axially guided. The pivot bearing 10, which is an axial and radial bearing, ensures that the pulling element 2 is not rotated but exclusively pulled or axially moveable. Thus, the pulling element 2 is connected to the slide 9 such that it is attached to a non-rotating part.

Furthermore, the device 1 comprises a blocking assembly 11 which can axially fasten or hold the slide 9 and thereby the pulling element 2. The blocking assembly 11 is also symmetric and includes, on each side, a blocking arm 12 which is supported at one side at the housing 25, respectively at the bearing point 15. The bearing point 15 is arranged close to the operating motor 3. A second pulling spring 16 is arranged at the other end, which pulls the blocking arm 12 in the direction of the slide 9. An electromagnet or an actuator 27 acts against the spring force of the second pulling spring 16. This actuator can also be provided as a clutch spring brake. In the area of the slide 9 the blocking arm 12 comprises a clamping region 13, which can be pressed against the blocking element 14, wherein the blocking element 14 is connected to the slide 9.

As depicted in FIG. 1, at least one translational element 7, which can also be the slide 9, is axially movable and axially guided and that rotatable parts 6 are present, as the rotating arms 18 with their weights 19, which are radially outwardly movable due to the centrifugal force. In this embodiment, the higher the rotating speed of the shaft 17, the higher the linear deflection of the translational element 7.

The device 1 according to the exemplary embodiment of the invention operates as follows:

The vehicle brakes are connected to an end of the pulling element 2, the end of which is not shown. The vehicle brakes pull with a certain spring force on the pulling element 2. To operate the vehicle brakes, this spring force must be exceeded.

When starting from a released state of the pulling cable 2, the slide 9 is positioned slightly more to the right than shown in FIG. 1. Although the pulling element 2 is in a released state, it should be recognized that the pulling element may have a certain pretension without operating the vehicle brakes The blocking arms 12 keep the slide 9 in this position. The operating motor 3 is still turned off.

If the parking brake is to be applied, the actuators 27 (e.g., electromagnets) are activated so that the blocking arms 12 open and the slide 9 is released. Simultaneously or subsequently, the operating motor 3 is activated or controlled, so that the shaft 17 is rotated. With increasing speed of the rotation, the weights 19 are pushed to the outside due to the centrifugal force. The forces of the pulling springs 24 are acting against the centrifugal force. The opening movement of the rotating arms 18 causes, via the pulling arms 21 (which are connected to the rotating arms 18), the slide 9 and the pulling cable 2, to be moved in the direction of the operating motor 3. Since the friction losses are comparatively low, electric power is applied to start the rotation of the rotating parts 5, but once the parts 5 are rotating, little or no additional electric energy is necessary. When the parts are rotating, the operating motor 3 needs comparatively little power.

When the slide 9 or the pulling element 2 has been pulled in the direction of the operating motor, the actuators 27 can be deactivated so that the blocking arms are closing again and the slide 9 is once again held in a fastened position. The operating motor 3 can then be turned off.

For a smooth or soft release of the parking brake, the operating motor 3 is started before the blocking arms 12 are opened again. By controlling or adjusting the operating motor 3, the pulling element 2 is moved back into the release position of the vehicle brake in a controlled manner. The pulling element 2 can be held with an optimal pretension, and if this pretension is achieved, the blocking arms 12 can close again and the operating motor 3 can be turned off again.

In the exemplary embodiment, all elements of the device 1 are arranged in a common housing 25 as a single unit. The arrangement shown in FIG. 1 is comparatively compact.

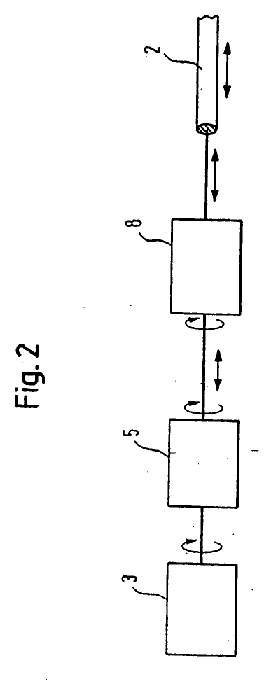

FIG. 2 shows a schematic representation to illustrate the decoupling of a rotational movement. Between the operating motor 3 and the centrifugal assembly 5 the rotational movement is decisive. Between the centrifugal assembly 5 and the decoupling device 8 an axial movement is already present, wherein the rotational movement is still present. No rotational movement is present between the pulling cable 2 and the decoupling device 8 so that the pulling element 2 is not rotated.

In this example, the pulling element 2 is a Bowden cable.

The invention is not limited to the described embodiment but comprises also other equivalent embodiments. For example, the pulling element 2 can be in an extreme case directly arranged with two pulling cables at the rotating arms 18, wherein the pulling element 2 can rotate within the housing 25. The decoupling of the rotational movement can also take place outside the device 1.

### List of Reference Signs

1 device
2 pulling element
3 operating motor
4 driving axis
5 centrifugal assembly
6 rotatable parts
7 translational element
8 decoupling device
9 slide
10 pivot bearing
11 blocking assembly
12 blocking arms
13 clamping region
14 blocking element
15 rotational bearing points
16 pulling springs
17 shaft
18 rotating arms
19 weight
20 first bearing point
21 pulling arms
22 second bearing point
23 third bearing point
24 pulling springs
25 housing
27 actuators

What is claimed is:

1. An apparatus for operating vehicle brakes comprising:
an operating motor comprising a rotatable driving axis;
a centrifugal assembly operatively connected to the rotatable driving axis;
a translational element disposed so as to be capable of axial movement relative to the rotatable driving axis, wherein the axial movement of the translational element is related to the rotational speed of the driving axis, and wherein the translational element is adapted so as to couple with a pulling element, wherein pulling element is coupled to the vehicle brakes.

2. The apparatus of claim 1, wherein the centrifugal assembly includes rotatable parts adapted so as to move outwardly in a radial direction relative to the rotatable driving axis in response to rotation of the centrifugal assembly.

3. The apparatus of claim 1 including:
a decoupling device, arranged between the centrifugal assembly and the pulling element, for decoupling the centrifugal assembly from the pulling element.

4. The apparatus of claim 3, wherein the decoupling device includes an axially guided slide and a pivot bearing arranged on the slide, wherein the pivot bearing is an axial and a radial bearing.

5. The apparatus of claim of claim 1, including:
a blocking assembly operable by actuators, the blocking assembly being positioned so that it can block, in a closed state, the axial movement of the translational element.

6. The apparatus of claim 5, wherein the blocking assembly includes at least two blocking arms hinged on one side at rotational bearing points, each of the blocking arms including a clamping region, wherein at least one blocking element connected to a slide is fastenably arranged between the blocking arms, wherein each of the actuators are positioned so as to be capable of contacting a corresponding one of the blocking arms and each of the actuators is positioned at a respective end of the blocking arms opposite to the rotational bearing points.

7. The apparatus of claim 6, wherein the actuators are electromagnets which are capable of opening the blocking arms against the spring force of second pulling springs, which are arranged at the ends of the blocking arms opposite to the rotational bearing points.

8. The apparatus of claim 1, wherein the centrifugal assembly comprises:
a shaft adapted so as to be coupled to the driving axis of the operating motor;
at least two rotating arms hinged to the shaft, each of the rotating arms including weights arranged at their free ends and each a first bearing point; and
at least two pulling arms which are each hingedly connected with one end to a second bearing point, wherein each of the second bearing points is fixed at the rotating arm between the weight and the first bearing point of the rotating arm and which are each attached at their other end with a slide to a third bearing point;
wherein the slide is axially and displaceably arranged at the, and wherein a pulling spring is arranged between each second bearing point and the shaft.

9. The apparatus of claim 1, wherein the operating motor, the centrifugal assembly, the decoupling device and the blocking assembly are arranged in a common housing as a single unit.

10. A method for operating vehicle brakes, the vehicle brakes coupled to a pulling element, wherein the pulling element is coupled to a slide capable of axial movement relative to a rotatable drive axis, the method comprising:
releasing, from a substantially fixed state, the slide so as to enable the slide to move along the rotatable drive axis;
rotating the rotatable drive axis with a motor, the rotatable drive axis being coupled to a centrifugal assembly that is coupled to the slide, wherein the centrifugal assembly rotates and at least a portion of the centrifugal assembly moves in a radial direction relative to the rotatable drive axis in response to the rotatable drive axis rotating, and wherein the radial movement of the centrifugal assembly pulls, via a pulling arm, the slide in the direction of the motor so as to place tension on the pulling element and place the vehicle brakes in an engaged state;
holding, after pulling the pulling element, the slide in an engaged position so as to maintain the vehicle brakes in the engaged state; and
ceasing to rotate the motor after the vehicle brakes are in the engaged state.

11. The method of claim 10 including:
releasing the slide so as to allow the slide to move from the engaged position;
rotating the rotatable drive axis with the motor so as to provide tension on the pulling element while allowing the slide to move, in a direction away from the motor, to a disengaged position so as to place the vehicle brakes in a disengaged state; and
holding the slide in the disengaged position so as to maintain the vehicle brakes in the disengaged state.

12. The method of claim 11, wherein the motor is started before the slide is released.

13. An apparatus for operating vehicle brakes, wherein the vehicle brakes are coupled to a pulling element, the apparatus comprising:
a translational element adapted so as to couple with the pulling element, wherein the translational element is capable of sliding along an axis from a disengaged position to an engaged position while pulling the pulling element so as to place the vehicle brakes in an engaged state;
means for pulling the translational element from a disengaged position to the engaged position; and
means for holding the translational element in the engaged position and disengaged positions and releasing the translational element so as to allow the translational element to move between the engaged and disengaged positions.

14. The apparatus of claim 13, wherein the means for pulling include means for rotating a centrifugal assembly about the axis, the centrifugal assembly including rotatable parts coupled to the translational element, wherein the rotatable parts are configured to move, when rotating about the axis, relative to the axis so as to pull the translational element from the disengaged position to the engaged position.

15. The apparatus of claim 14 wherein the means for rotating includes a motor coupled to a rotatable driving shaft, wherein the rotatable driving shaft is aligned along the axis and the centrifugal assembly is coupled to the rotatable driving shaft.

16. The apparatus of claim 13, wherein the means for holding includes a blocking arm, wherein the blocking arm is configured to contact the translational element so as to hold the translational element in the engaged position.

17. The apparatus of claim 16, wherein the means for releasing includes an actuator adapted to pull the blocking arm away from the translational element so as to release the translational element.

18. The apparatus of claim 13 including means for maintaining tension on the pulling element while the translational element is moving from the engaged position to the disengaged position.

19. The apparatus of claim 18, wherein the means for maintaining tension include means for rotating a centrifugal assembly about the axis, the centrifugal assembly including rotatable parts coupled to the translational element, wherein the rotatable parts are configured to move, when rotating about the axis, relative to the axis so as to place tension on the translational element while the translational element is moving from engaged position to the disengaged position.

20. The apparatus of claim 19 wherein the means for rotating includes a motor coupled to a rotatable driving shaft, wherein the rotatable driving shaft is aligned along the axis and the centrifugal assembly is coupled to the rotatable driving shaft.
